(19) United States
(12) Patent Application Publication
(10) Pub. No.: US 2026/0254407 A1
(43) Pub. Date: Aug. 27, 2026

(54) A METHOD AND APPARATUS FOR COLLECTING, TRANSPORTING AND DISTRIBUTING ENERGY

(71) Applicant: ATOA Scientific Technologies Pvt. Ltd, BANGALORE (IN)

(72) Inventor: Raj CN Thiagarajan, BANGALORE (IN)

(73) Assignee: ATOA Scientific Technologies Pvt. Ltd, BANGALORE (IN)

(21) Appl. No.: 18/871,236

(22) PCT Filed: Jun. 23, 2022
(86) PCT No.: PCT/IB2022/055814

§ 371 Date: Dec. 3, 2024

(30) Foreign Application Priority Data
Jun. 22, 2022 (IN) 202241035855

(51) Int. Cl. H02S 40/22; G02B 6/02; H02J 50/30; H04B 10/80

(52) U.S. Cl. CPC H02S 40/22; G02B 6/02304; G02B 6/02309; H02J 50/30; H04B 10/807

(57) ABSTRACT

The present disclosure provides a method and an apparatus for collecting, transporting and distribution energy. The apparatus includes a first node (101a) for collecting energy emitted from a source and a second node (101b) for receiving the energy from the source node (101a). The first node (101a) includes a collector unit (103) for collecting the energy emitted from the source and a concentrator unit (104) for concentrating the collected energy. A secondary channel transmitter (105) is provided for storing and releasing the concentrated energy received from the concentrating unit (104), a primary channel transmitter (106) is connected to the secondary channel transmitter (105) for converging the released concentrated energy and a transport channel (107) is connected to the first node (101a) and the second node (101b) for transmitting the concentrated energy from the primary channel transmitter (106) to the second node (101b).

### FIELD

The embodiments herein generally relate to collecting, transporting and distributing energy. More particularly, the disclosure relates to a method and an apparatus for collecting energy from a location and transporting energy to another location.

### BACKGROUND AND PRIOR ART

Renewable and sustainable sources of energy are in a great demand due to increasing cost of producing electricity from fossil fuels, global warming and a need for reducing pollution. Solar energy is a widely used form of renewable energy harvested through various means for many purposes. Solar radiation is essential for life, and available 24×7 on the Earth at different locations at different points of time. Harnessing solar energy in an efficient, cost effective, direct and continuous way is essential for a sustainable future.

Availability of direct solar energy time is limited on a given location level on the earth, due to the rotation of the earth. Direct solar light energy is available at a given location, city, or village only during daytime, prompting people to use artificial sources of light during night time. However, it is desirable for availability of a renewable source of energy such as solar light energy during night time for illumination.

Conventionally, there are many technologies, devices and systems converting solar energy into various forms of energy such as electricity for reconversion into useful form of energy such as lighting. This process of conversion and reconversion requires enormous resources, heavy equipment, a complex conversion and reconversion system, expensive and results in wastage of energy. Hence, such systems limit the availability of renewable energy sources to remote locations and the needy.

Therefore, there is a need for an efficient and cost-effective apparatus for collecting sunlight at a location at daytime and transporting to another location at nig time. Moreover, there is a need for an apparatus and method to transport solar energy through longer distances across different time zones with low loss.

### Objects

Some of the objects of the present disclosure are described herein below:

The main objective of the present disclosure is to provide an apparatus and method for transporting energy.

Another objective of the present disclosure is to provide an apparatus and method for transporting solar energy to locations in different time zones.

Still another objective of the present disclosure is to provide an apparatus and method for dual way transportation of solar energy from a location with availability of solar energy to a location with non-availability of solar energy.

Yet another objective of the present disclosure is to provide an apparatus and method for solar energy collection, transport and distribution for collecting solar energy, concentrating the energy, transporting the energy to long distances with minimal loss to another part of the world, receiving and distributing the solar energy for illumination purposes, wherein the apparatus works in forward mode for the first 12 hours and works in the reverse mode for the next 12 hours.

Still another objective of the present disclosure is to provide an apparatus and method with multiple connections, bracing, terminal, switching, load balancing and distribution network across the globe for solar energy for illumination purposes.

Yet another objective of the present disclosure is to provide an apparatus and method for solar energy collection, transportation and distribution connecting locations with a time zone difference of 3-18 hrs for solar energy for reversible illumination purposes.

Still another objective of the present disclosure is to provide an apparatus and method for Solar Energy Collection, Transportation and Distribution with low loss and high efficient, collection, focus, secondary focus, long distance transport, coupling, splicing, distribution, network system.

Yet another objective of the present disclosure is to provide an apparatus and method having a global network of solar energy collection, transportation and distribution.

Still another objective of the present disclosure is to provide an apparatus and method for global solar energy collection, transport and distribution system with communication for combined illumination and telecommunication purpose.

Yet another objective of the present disclosure is to provide an apparatus and method for solar energy collection, transport and distribution system for street, road, railway track, airport runway, green house, outdoor, residential and industrial, indoor lighting/illumination.

Still another objective of the present disclosure is to provide an apparatus and method including a low loss transport channel, which can transmit light, especially broadband solar light energy for long-distance or transcontinental transport without amplifiers.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides an apparatus and method for collecting, transporting and distributing energy.

In accordance with an embodiment, the apparatus, comprising a first node provided at a first location as a source node for collecting energy emitted from a source, a second node provided at a second location as a receiver node for receiving the energy from the source node. The first node includes a collector unit for collecting the energy emitted from the source, a concentrating unit for concentrating the collected energy, a secondary channel transmitter for storing and releasing the concentrated energy received from the concentrating unit, a primary channel transmitter connected to the secondary channel transmitter for converging the released concentrated energy and a transport channel connected to the first node and the second node for transmitting the concentrated energy from the primary channel transmitter to the second node.

In accordance with an embodiment, the second node including a primary channel receiver for diverging the concentrated energy received from the transport channel, a secondary channel receiver connected to the primary channel receiver for storing and releasing the concentrated energy, a de-concentrator for scattering the concentrated energy released from the secondary channel receiver and a reflector reflecting the scattered light for illumination.

In accordance with an embodiment, the second node functioning as the source node during availability of the source at the second location and the first node functioning as the receiver node during non-availability of the source at the first location.

In an embodiment, the second node includes a top surface of the reflector unit functioning as the collector unit for collecting the energy, the de-concentrator unit functioning as the concentrator unit for concentrating the collected energy, the secondary channel receiver functioning as the secondary channel transmitter for storing and controlling release of the concentrated energy, the primary channel receiver functioning as the primary channel transmitter, the transport channel transporting the concentrated energy to the first node and the channel receiver for receiving the concentrated energy, the secondary channel transmitter functioning as the secondary channel receiver for storing releasing the concentrated energy, the concentrator unit functioning as the de-concentrator unit for scattering the concentrated energy and a bottom surface of the collector unit functioning as the reflector unit.

In accordance with an embodiment, the energy is solar energy in a form of broadband light energy and the source is the sun.

In accordance with an embodiment, the transport channel includes solid core optical fiber and the solid core optical fiber includes three layers with three different refractive indices.

In accordance with an embodiment, the transport channel includes air core solar optical fiber and the air core solar optical fiber includes an air core and an outer portion with graded refractive index.

In accordance with an embodiment, the transport channel includes an air core solar brag fiber and the air core solar brag fiber including an air core and mul layers of mismatched refractive index. In an embodiment, the multi layers of mismatched refractive index one of alternate layer of mismatched refractive index and alternate concentric layer of mismatched refractive index.

In accordance with an embodiment, the transport channel includes an air core photonic crystal fiber and the air core photonic crystal fiber including a core with variable refractive index materials.

In accordance with an embodiment, the transport channel including a meta fiber with alternate refractive index material circumferentially and in inclusions.

In accordance with an embodiment, optical means of the collector unit 103, the reflector unit 111, the concentrator unit 104, the de-concentrator unit 110, the primary channel transmitter 106, the primary channel receiver 108, the secondary channel transmitter 105 and the secondary channel receiver 109 including one or a combination of ray, inference, diffractive, photonic, and meta optical elements.

In accordance with an embodiment, the first location of the first node and the second location of the second node provided at different time zones varying from 3 hours to 18 hours.

In accordance with an embodiment, the distribution of energy around the earth through a distribution network including plurality of nodes collecting and concentrating energy from the source, a plurality of branches extending from the nodes for transmitting the concentrated energy, a plurality of terminals connected to the branches for receiving the energy from the nodes and transmitting the concentrated energy, a switch connected to the terminals for transmitting the concentrated energy to another switch for distribution and the other switch distributing the energy to plurality of nodes through the terminals and branches for illumination. In an embodiment, the distribution network distributing energy through connections of coupling, splicing, terminals, switching and load balancing between the nodes.

In accordance with an embodiment, the method for transporting light, comprises the steps of collecting energy from a source by a collector unit provided in a first node, concentrating the collected energy by a concentrator unit provided in the first node, storing the collected energy and releasing the stored energy by a secondary channel transmitter provided in the first node, converging and transmitting the stored energy to a transport channel, by a primary transmitter provided in the first node and transporting the energy to a second node, by the transport channel for illumination through reflection. Then, receiving and diverging the concentrated energy received from the transport channel by a primary channel receiver in the second node, storing and releasing the concentrated energy by a secondary channel receiver connected to the primary channel receiver, scattering the concentrated energy released from the secondary channel receiver by a de-concentrator and reflecting the scattered light for illumination, by a reflector.

In accordance with an embodiment, the method including distributing the energy around the earth through a distribution network comprising the steps of collecting and concentrating energy from the source, by plurality of nodes, transmitting the concentrated energy by a plurality of branches extending from the nodes, receiving and transmitting the concentrated energy by a plurality of terminals connected to the branches, transmitting the concentrated energy to another switch by a switch connected to the terminals for distribution and distributing the energy by the other switch to plurality of nodes through the terminals and branches for illumination.

In an embodiment, the distribution network distributing energy through connections of coupling, splicing, terminals, switching and load balancing between the nodes.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1a illustrates a schematic of an apparatus for collecting, transporting and distributing energy, according to an embodiment herein;

FIG. 1b illustrates a schematic of a map including the first node and the second node, according to an embodiment herein;

FIG. 2a illustrating a schematic of collecting, transporting and distributing energy from the second node to the first node, according to an embodiment herein;

FIG. 2b illustrates a schematic of a map including the first node and the second node, according to an embodiment herein;

FIG. 3 illustrates a schematic of a dual system for collecting, transporting and distributing energy, according to an embodiment herein;

FIG. 4a illustrates a perspective view of the first node/second node of the system.

FIG. 4b illustrates a front view of the first node/second node of the system, according to an embodiment herein;

FIG. 4c illustrates a magnified view of the secondary channel transmitter and the secondary channel receiver, and the primary channel transmitter and the primary channel receiver, according to an embodiment herein;

FIG. 4d illustrates a magnified view of the collector unit/the reflector unit and the concentrator unit/the de-concentrator unit, according to an embodiment herein;

FIG. 5a illustrates a top surface of the collector unit maximizing collection of the energy, according to an embodiment herein;

FIG. 5b illustrates a magnified front view of the collector unit maximizing collection of the energy, according to an embodiment herein;

FIG. 5c illustrates a front view the collector unit and the reflector unit, according to an embodiment herein;

FIG. 6a illustrates a cross-sectional view of the transport channel, according to an embodiment herein;

FIG. 6b illustrates a cross-sectional view of plurality of embodiment of the meta fiber ballistic transport, according to an embodiment herein;

FIG. 7 illustrates a perspective view of the apparatus system for collecting, transporting and distributing energy, according to an embodiment herein;

FIG. 8 illustrates tracking mechanism of the collector unit of the apparatus, according to an embodiment herein;

FIG. 9a illustrating a distribution network of dual node three set apparatus, according to an embodiment herein;

FIG. 9b illustrating a distribution network of dual node six set apparatus, according to an embodiment herein;

FIG. 9c illustrating a distribution network of dual node six set and three set booster apparatus, according to an embodiment herein;

FIG. 10a illustrates a map of the global distribution network linking locations 12 hours apart, according to an embodiment herein;

FIG. 10b illustrates a map of the global distribution network linking locations 10-14 hours apart, according to an embodiment herein;

FIGS. 11a and 11b illustrate a 3D ray tracing computational simulation result for the energy in apparatus of FIG. 1a, according to an embodiment herein;

FIGS. 12a and 12b illustrate a 3D ray tracing computational simulation result for the energy in apparatus of FIG. 2a, according to an embodiment herein;

FIG. 13 illustrates a 3D ray tracing computational simulation result for the energy in apparatus of FIG. 3, according to an embodiment herein;

FIG. 14 illustrates a graph of reflectance in % vs vacuum wavelength in nm for solar energy transmission window for air core Brag fibers with multilayer, according to an embodiment herein;

FIG. 15a illustrates a graph of reflectance in % vs vacuum wavelength in nm for solar energy transmission window for Air core Photonic crystal fiber and Meta fiber ballistic transport, according to an embodiment herein;

FIG. 15b illustrates computational simulation results for cross-sectional shapes of the transport channel of Air core Photonic crystal fiber and Meta fiber ballistic transport, according to an embodiment herein.

### LIST OF NUMERALS

101a—First node
101b—Second node
102—Energy
103—Collector unit
104—Concentrator unit
105—Secondary channel transmitter
106—Primary channel transmitter
106a—First end of primary channel transmitter
106b—Second end of primary channel transmitter
107—Transport channel
108—Primary channel receiver
109—Secondary channel receiver
110—De-concentrator unit
111—Reflector unit
601—Inclusion
901—Branch
902—Terminal
904—Switch
1001—Distribution link

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

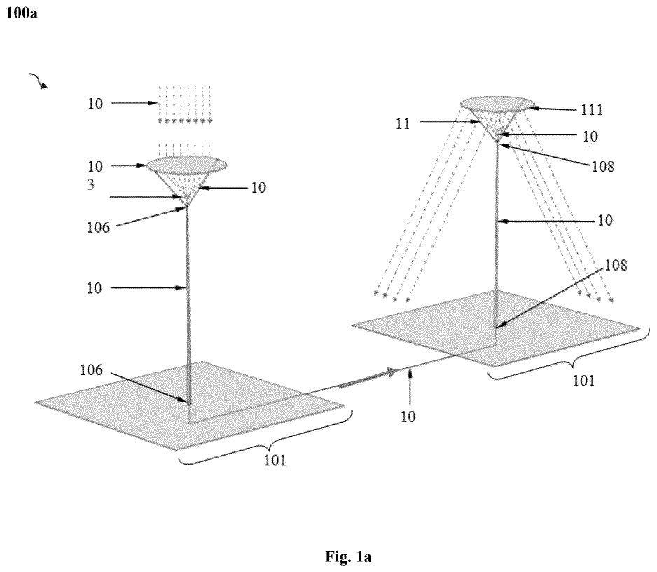

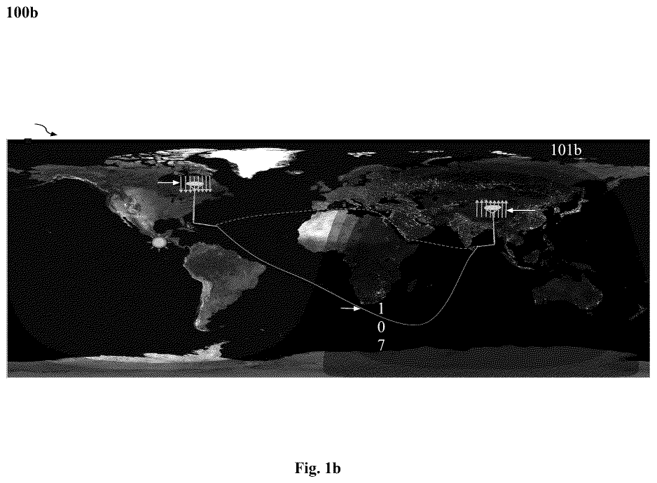

As mentioned above, there is a need for an efficient and cost-effective apparatus for collecting sunlight at a location at daytime and transporting to another location at night time. In particular, there is a need for an apparatus and method to transport solar energy through longer distances across different time zones with low loss. The embodiments herein achieve this by providing “A method and apparatus for collecting, transporting and distributing energy”. Referring now to the drawings, and more particularly to FIG. 1a through FIG. 15b, where similar reference characters denote corresponding features consistently throughout the figures, there are shown preferred embodiments.

FIG. 1a illustrates a schematic of an apparatus for collecting, transporting and distributing energy. In an embodiment, the apparatus includes a first node 101a, a second node 101b and a transport channel 107. The first node 101a located in a region with availability of a source of energy 102 functioning as a source node and the second node 101b located in a region with non-availability of the source of energy functioning as a receiver node.

In an embodiment, the first node 101a is provided for collecting energy emitted from a source, storing the energy and releasing the energy. The first node 101a including a collector unit 103, a concentrator unit 104, a secondary channel transmitter 105 and a primary channel transmitter 106. The collector unit 103 is provided for collecting the energy 102 emitted from the source. The collector unit 103 focuses the collected energy to the concentrator unit 104. The concentrator unit 104 is connected to the collector unit 103, and provided for concentrating the energy received from the collector unit 103. In an embodiment, the concentrator unit 104 includes optical means for concentrating the energy received from the collector unit 104. The collector unit 104 transmits the concentrated energy to the secondary channel transmitter 105.

In an embodiment, the collector unit 103 including lens, Fresnel lens, parabolic lens and multiple focusing element.

In an embodiment, source of energy is the Sun. The Ultraviolet (UV) light is up converted to visible light and the Infrared (IR) light is down converted to visible light using conventional means by the collector unit.

In an embodiment, the secondary channel transmitter 105 is provided for storing the concentrated energy received from the concentrator unit 104. The secondary channel transmitter 105 controls release of the concentrated energy.

In an embodiment, the secondary channel transmitter 105 includes optical means for storing the concentrated energy without significant loss. The secondary channel transmitter 105 includes means for controlling release of the stored concentrated energy. The concentrated energy released from the secondary channel transmitter 105 is directed to the primary channel transmitter 106.

In an embodiment, the primary channel transmitter 106 includes a first end 106a and a second end 106b. The first end 106a is connected to the secondary channel transmitter 105 and the second end 106b is connected to the transport channel 107. The primary channel transmitter 106 is provided for converging the concentrated energy received from the secondary channel transmitter 105. The concentrated energy is converged in the primary channel transmitter 106 for transmitting the concentrated energy to the transport channel 107 through the second end 106b.

In an embodiment, the transport channel 107 is connected to the first node 101a and the second node 101b. One end of the transport channel 107 is connected to the second end 106b of the primary channel transmitter 106 of the first node 101a. In an embodiment, the transport channel 107 is provided for transmitting the concentrated energy received from the primary channel transmitter 106 to the second node 101b with low loss. In an embodiment, the loss is lesser than 0.0001 db/km. The transport channel 107 includes optical means for transporting the concentrating energy through long distances.

In an embodiment, the optical means of the transport channel 107 including but not limited to one or a combination of solid core optical fiber, air core optical fiber, air core brag fiber, air core photonic crystal fiber, and meta fiber for ballistic transport.

The transport channel 107 transports the concentrated energy to the second node 101b. In an embodiment, material of the transport channels including but not limited to one or a combination of plastic, glass, silicon, halide, composites, and meta composites.

In an embodiment, the second node 101b is provided for receiving, storing, releasing and reflecting the concentrated energy for illumination. The second node 101b including a primary channel transmitter 108, a secondary channel transmitter 109, a de-concentrator unit 110, and a reflector unit 111. The primary channel receiver 108 includes a first end 108a and a second end 108b. The second end 108b of the primary channel receiver 108 is connected to the transport channel 107. The primary channel receiver 108 is provided for receiving the concentrated energy transported by the transport channel 107. The primary channel receiver 108 includes optical means for diverging the concentrated energy and directing the energy to the secondary channel receiver 109.

The secondary channel receiver 109 is connected to the primary channel receiver 108 for storing and releasing the concentrated energy. In an embodiment the secondary channel receiver 109 includes optical means for storing the concentrated energy with low loss. The secondary channel receiver includes means for controlling release of the concentrated energy. The means is used for releasing the concentrated energy and directing to the de-concentrator unit 110.

In an embodiment, the de-concentrator unit 110 is provided for scattering the concentrated energy. The de-concentrator unit 110 includes optical means for scattering the concentrated light and directing the scattered energy to the reflector unit 111.

The reflector unit 111 is provided for reflecting the energy scattered from the de-concentrator unit 110 and illuminating an area.

In an embodiment, optical means of the collector unit 103, the reflector unit 111, the concentrator unit 104, the de-concentrator unit 110, the primary channel transmitter 106, the primary channel receiver 108, the secondary channel transmitter 105 and the secondary channel receiver 109 including but not limited to ray, inference, diffractive, photonic, and meta optical elements. In an embodiment, length scale of the optical means including but not limited to macro, micro and nano level. In an embodiment, material of the optical means including but not limited to one or a combination of plastic, glass, composites, and meta composites.

In an embodiment, the energy 102 is a light energy, wherein the source is a light source. In a preferred embodiment, the source is the Sun, and the energy is solar energy in a form of light.

In an embodiment, the energy which is collected, stored, focused and reflected includes energy from the solar spectrum in the Ultra Violet region having wavelength ranging from 280 nm to 380 nm and frequency ranging from 800 THz to 30,000 THz, visible light region having wavelength ranging from 380 nm to 780 nm and frequency ranging from 400 THz-800 THz, near infrared region having wavelength ranging from 780 nm to 1400 nm and frequency ranging from 215 THz-300 THz, Middle infrared region having wavelength ranging from 1400 nm to 3000 nm and frequency ranging from 30 THz-120 THz and far infrared having wavelength ranging from 1000 nm to 2500 nm and frequency ranging from 300 GHz to 30 THz. Thermal radiation range of wavelength spans from 100 nm to 100,000 nm. Visible light is a very small part of the electromagnetic spectrum from solar radiation. The energy source is not limited to visible light of the electromagnetic spectrum.

FIG. 1b illustrates a schematic of a map including the first node and the second node. In an embodiment, the system including nodes placed at two locations having different time zones wherein a first location at day time with availability of the sun and a second location at night time with non-availability of the sun. The node placed at the first location at day time acting as the source node 101a and the node placed at the second location at night time acting as the receiver node 101b. The source node 101a collecting, storing and transporting the energy through the transport channel 107 to the receiver node 101b for illumination at night time.

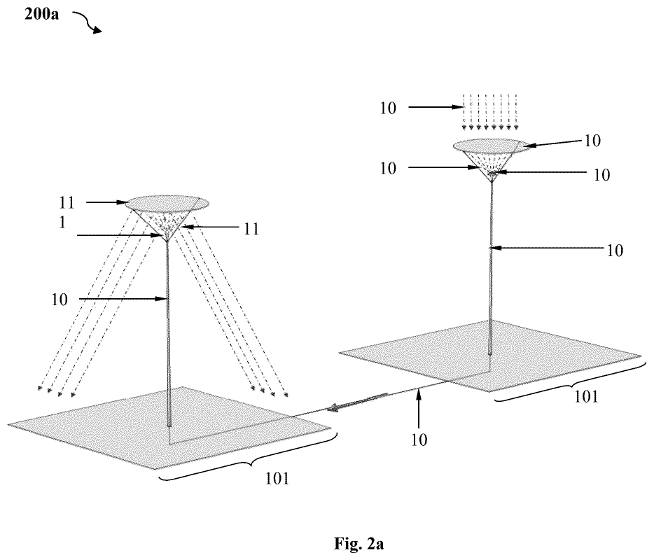

FIG. 2a illustrating a schematic of collecting, transporting and distributing energy from the second node to the first node. In an embodiment, the second node 101b functions as the source node 101a during availability of energy and the first node 101a functions as the receiver node during non-availability of the energy. In an embodiment, in the second node 101b, the reflector unit 111 functioning as the collector unit 103 collects the energy 102, the de-concentrator unit 110 functioning as the concentrator unit 104 concentrates the collected energy, the secondary channel receiver 109 functioning as the secondary channel transmitter 105 stores and controls release of the concentrated energy to the primary channel receiver 108 functioning as the primary channel transmitter 106. The transport channel 107 transports the concentrated energy to the first node 101a functioning as the receiver node. The primary channel transmitter 106 functioning as the primary channel receiver 108 receives the concentrated energy and transmits to the secondary channel transmitter 105 functioning as the secondary channel receiver for storing and releasing the energy. The released concentrated energy is reflected by the collector unit 103 functioning as the reflector unit, thereby illuminating a location during non-availability of energy.

FIG. 2b illustrates a schematic of a map including the first node and the second node. In an embodiment, during night time, the first node 101a functioning as the receiver node receives concentrated energy from the second node 101b functioning as the source node 101a during day time.

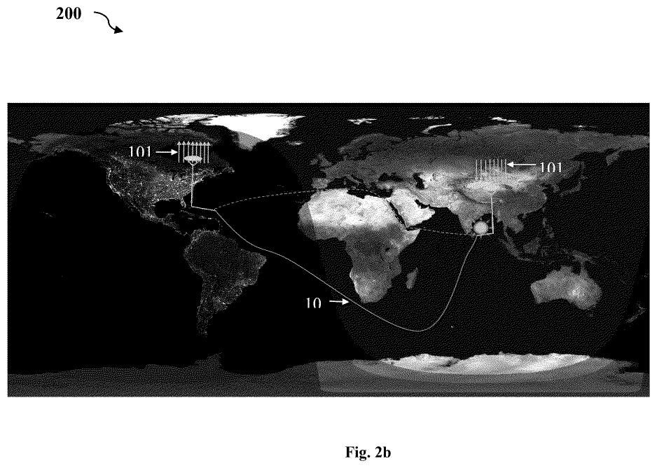

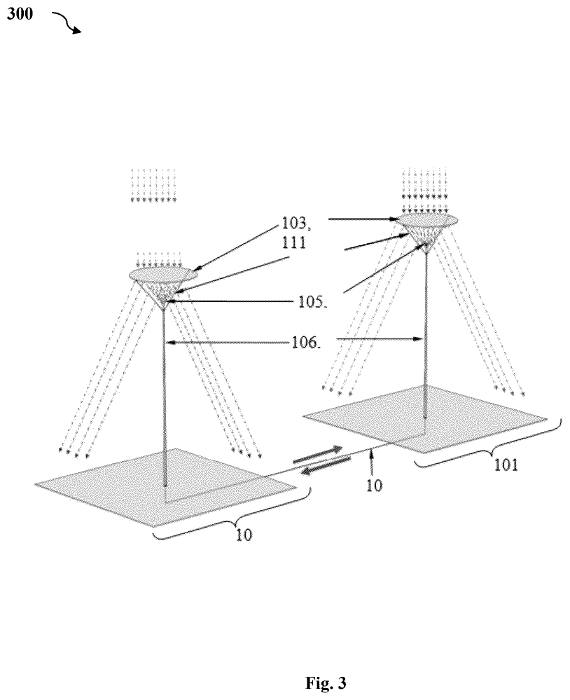

FIG. 3 illustrates a schematic of a dual system for collecting, transporting and distributing energy. In an embodiment, during availability of source of energy the first node 101a functions as the source node for collecting, storing, releasing and transporting energy through the transport channel 107 to the second node 101b at another location functioning as the receiver node. During availability of the energy at the location of the second node 101b, the second node 101b functions as the source node for collecting, storing, releasing and transporting energy through the transport channel 107 to the first node 101a functioning as the receiver node.

In an embodiment, the first node 101a functions as the source node for 12 hours during day time and availability of the sun, and the second node 101b functions as the receiver node for 12 hours during night time and non-availability of the sun. During day time at the location of the second node 101b, the second node 101b functions as the source node for 12 hours of availability of the sun and the first node 101a functions as the receiver node for 12 hours of night time during non-availability of the sun.

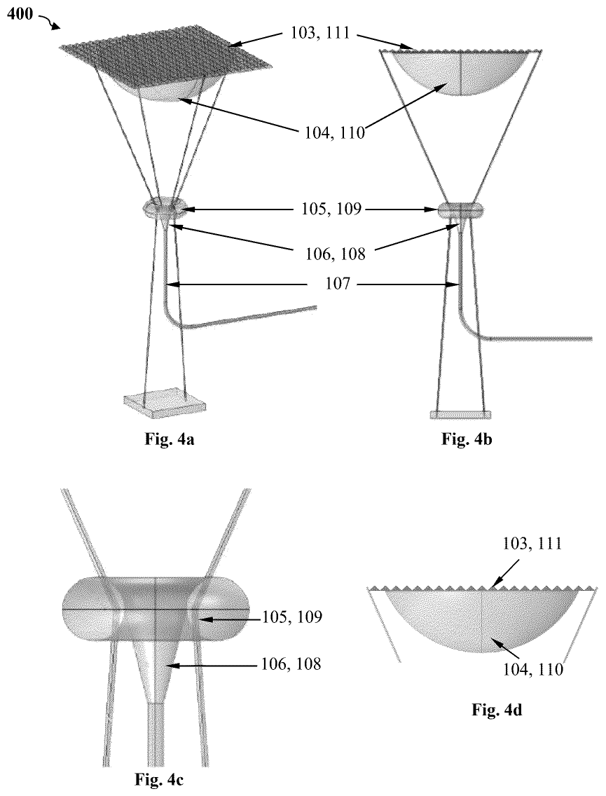

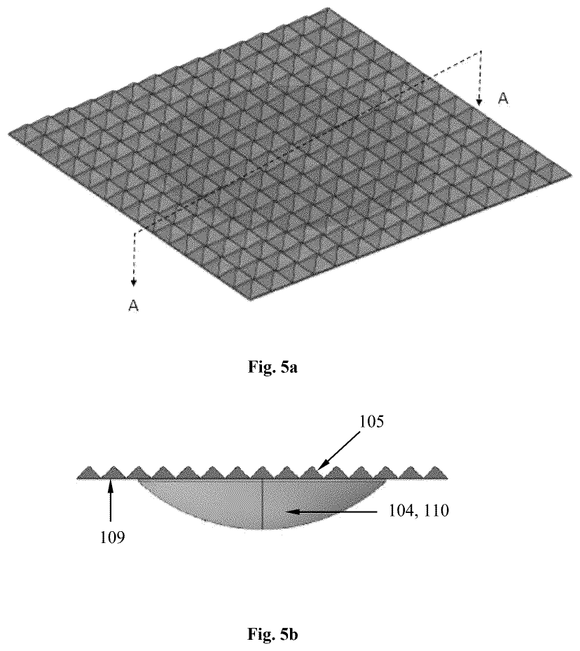

FIG. 4a illustrates a perspective view of the first node/second node of the system. FIG. 4b illustrates a front view of the first node/second node of the system. The first node and/or the second node 101a, 101b includes the collector unit 103 and the reflector unit 111, the concentrator unit 104 and the de-concentrator unit 110, the secondary channel transmitter 105 and the secondary channel receiver 109, and the primary channel transmitter 106 and the primary channel receiver 108.

FIG. 4c illustrates a magnified view of the secondary channel transmitter 105 and the secondary channel receiver 109, and the primary channel transmitter 106 and the primary channel receiver 108.

In an embodiment, the secondary channel transmitter 105 provided in the source node for storing the concentrated energy received from the concentrator unit 104. The secondary channel transmitter 105 includes optical elements for storing the concentrated energy without loss through total internal reflection.

In an embodiment, the secondary channel transmitter 105 functions as the secondary channel receiver 109 for receiving the concentrated energy from the transport channel 107 through the primary channel receiver 108 and storing the concentrated energy with low loss.

In an embodiment, the secondary channel transmitter 105 including a means connected to the primary channel transmitter 108 for releasing the stored concentrated energy. In an embodiment, the secondary channel receiver 109 including the means connected to the primary channel receiver 108 for receiving the concentrated energy. In an embodiment, the means provided for releasing the stored concentrated energy and receiving the concentrated energy.

In an embodiment, the primary channel transmitter 106 provided for transmitting the concentrated energy from the secondary channel transmitter 108 to the transport channel 107. In an embodiment, the primary channel receiver 108 provided for receiving the concentrated energy from the transport channel 107.

In an embodiment, the primary channel transmitter 106 provided as a converging shape and the primary channel receiver 108 provided as a diverging shape.

FIG. 4d illustrates a magnified view of the collector unit 103/the reflector unit 111 and the concentrator unit 104/the de-concentrator unit 110. In an embodiment, the collector unit 103 collecting energy from the source from a top surface, wherein the top surface maximizing collection of sunlight through the optical means. In an embodiment, the collector unit 103 functioning as the reflector unit 111, wherein a bottom surface of the collector unit 103 functioning as the reflector unit 111 for reflecting the concentrated energy for illumination.

In an embodiment, the concentrator unit 104 including optical elements for focusing the energy collected by the collector unit 103 and transmitting to the concentrator unit 104. The de-concentrator unit 110 including optical elements for scattering the energy received from the secondary channel receiver 109 and transmitting to the reflector unit 111.

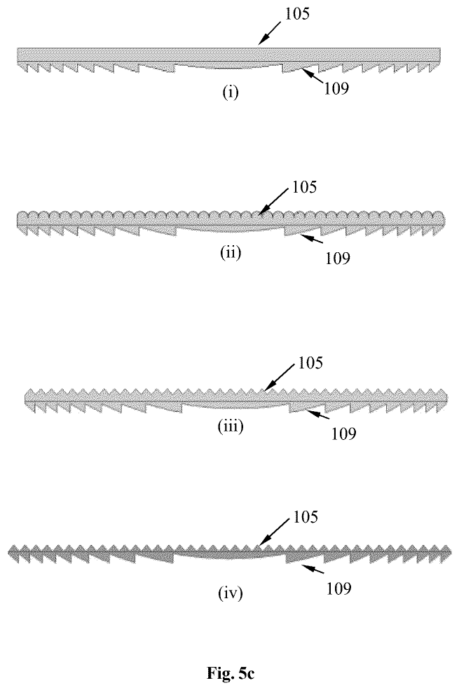

FIG. 5a illustrates a top surface of the collector unit maximizing collection of the energy.

FIG. 5b illustrates a magnified front view of the collector unit maximizing collection of the energy. The top surface including plurality of prism shaped optical means for maximizing collection of the energy.

FIG. 5c illustrates a front view the collector unit and the reflector unit. (i), (ii), (iii), and (iv) illustrate a plurality of shapes of surface of the collector unit 104 for maximizing collection of the energy and the reflector unit 111 for efficiently reflecting the concentrated energy.

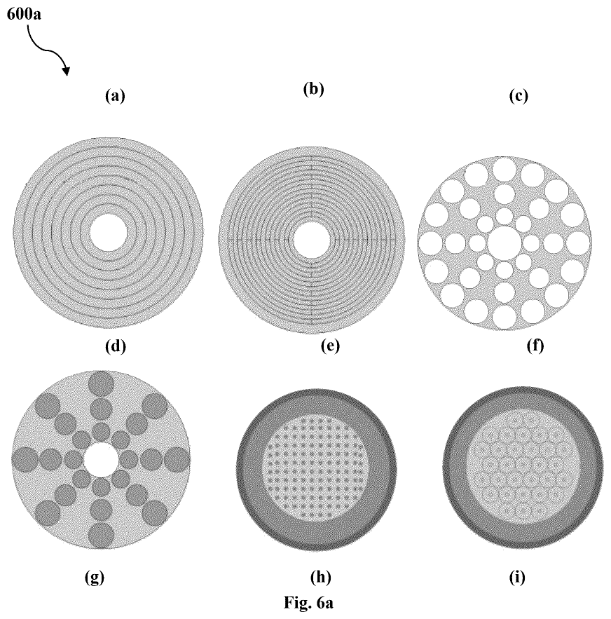

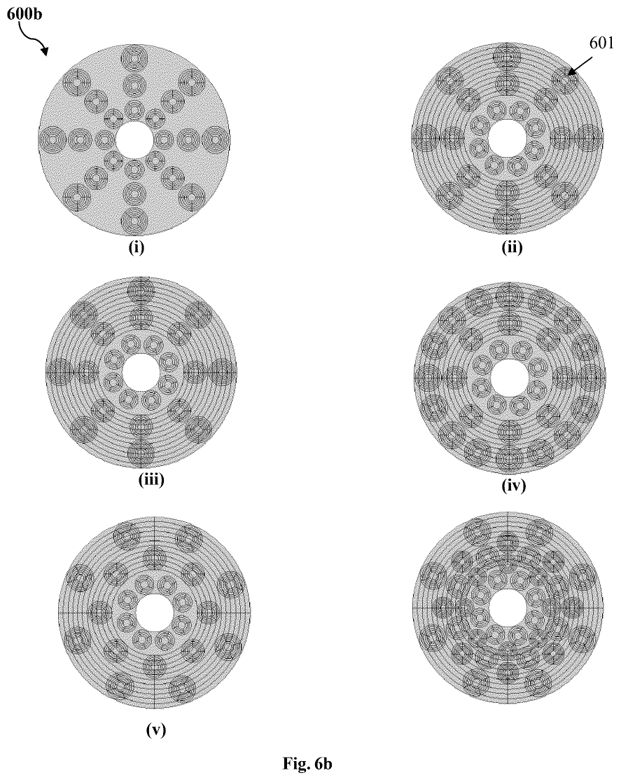

FIG. 6a illustrates a cross-sectional view of the transport channel. In an embodiment, the transport channel is provided for transporting concentrated energy from the source node to the receiver node with low loss, wherein the loss lesser than 0.0001 db/km. In an embodiment, the transport channel 107 including but not limited to one or a combination of solid core optical fibers, air core optical fibers, air core brag fibers, air core photonic crystal fiber, meta fiber for ballistic transport. The transport channel including a core transport channel for transmitting the energy, cladding, structural support and protective layers. The transport channel 107 provided for transporting energy including but not limited to solar energy, light energy, communication waves.

In an embodiment, (a) illustrates a cross-sectional view of solid core optical fibers, (b) illustrates a cross-sectional view of air core optical fibers, (c) illustrates a cross-sectional view of metal fiber ballistic transport, (d) and (e) illustrate a cross-sectional view of air core brag fibers, (f) and (g) illustrate a cross-sectional view of air core photonic crystal fibers. In an embodiment, (h) and (i) illustrate a cross-sectional view of transport channel support system

The transport channel includes multi layers for transmit broad band solar energy without loss for long distances. The transport channel transmitting the energy without loss using optical means through ray optics, wave optics and photonic mechanism, leveraging total internal reflection, wave guiding and quantum mechanical property.

In an embodiment, solid core optical fibers (a) including three layers, of three different refractive indices. The solid core optical fibers transmitting broad band solar energy in a wavelength ranging from 480 nm to 780 nm.

In an embodiment, air core solar optical fibers (b) including an air or vacuum core for transmitting the energy. The air core solar optical fibers (b) including graded refractive index outer portion. In an embodiment, refractive index of outer portion of the air core solar optical fibers (b) ranging from 1 to 5, specifically from 1 to 4, more specifically from 1 to 3, more specifically from 1 to 2, more specifically from 1 to 1.5. Loss during transmission is lower in the air core solar optical fiber as attenuation of air is lower in the air core.

In an embodiment, the air core solar brag fibers (d), (e) enable transmission of solar energy through air or vacuum core. The air core solar brag optical fiber (d) includes an air core and multi-layer of alternative layer of mismatched refractive index and the air core solar brag optical fiber (e) includes an air core and multi-layer of alternative concentric layer of mismatched refractive index.

In an embodiment, the air core solar photonic crystal fiber (f), (g) including a with variable refractive index materials for effective refractive index to allow only transmission modes.

FIG. 6b illustrates a cross-sectional view of plurality of embodiment of the meta fiber ballistic transport. In an embodiment, the meta fiber ballistic transport including multilayers of alternative refractive index material multilevel for ballistic transport. In an embodiment, the refractive index material varying varying circumferentially and varying at inclusions 601 provided in the cross-sectional area.

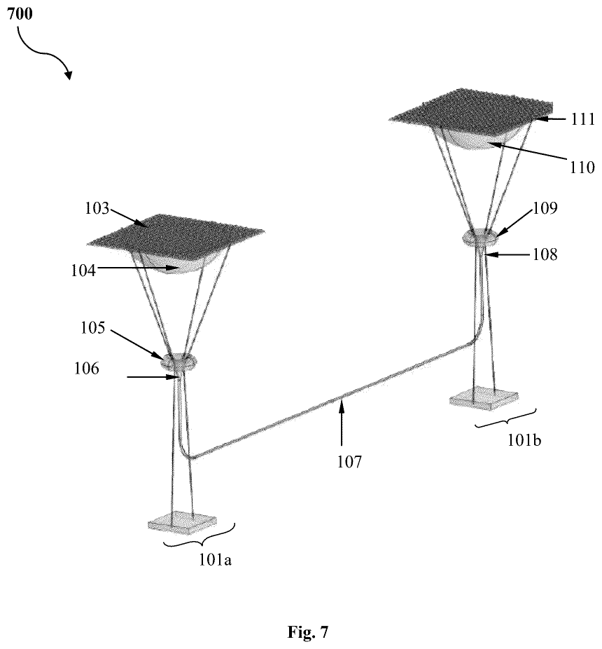

FIG. 7 illustrates a perspective view of the apparatus system for collecting, transporting and distributing energy. In an embodiment the transport channel 107 transmitting the energy through distances ranging from 8000 km to 24000 km.

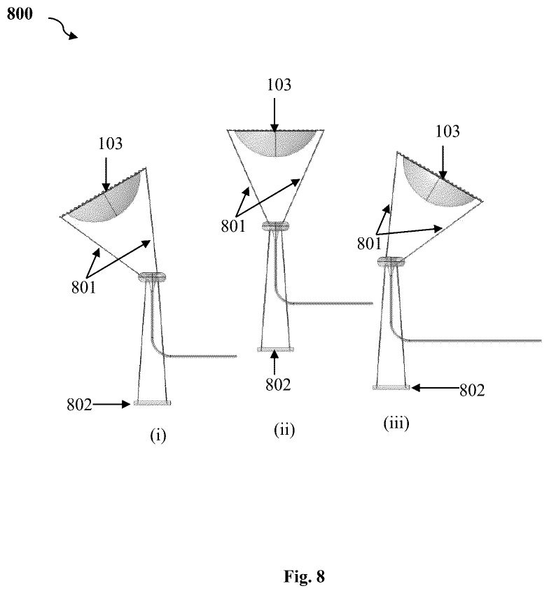

FIG. 8 illustrates tracking mechanism of the collector unit of the apparatus. In an embodiment, a tracking mechanism provided on the collector unit for changing orientation of the collector unit towards the source of energy for maximizing collection of the energy. In an embodiment, the tracking mechanism connected to structure elements 801 supporting the collector unit 103, wherein the tracking mechanism moving the structural elements 801 relative to a foundation 802, towards the source of the energy. The tracking mechanism including a sensor for detecting position of the sun and an actuator for moving the structural elements towards the position of the sun. (i), (ii) and (iii) illustrate orientations of the structural unit 801 relative to the foundation 802.

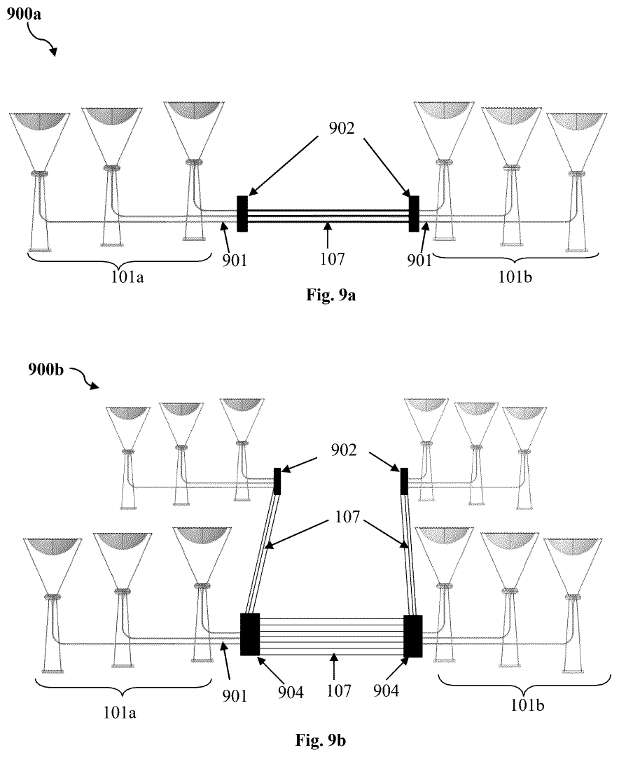

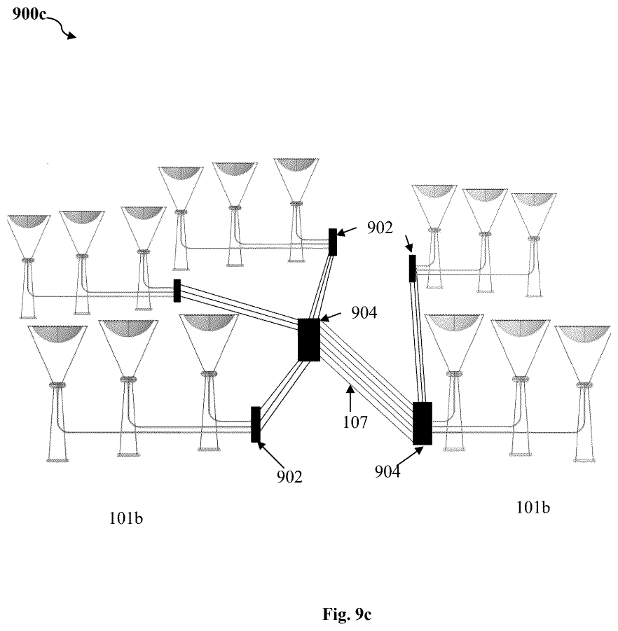

FIG. 9a illustrating a distribution network of dual node three set apparatus. In an embodiment, the distribution network including plurality of nodes provided in multiple locations for transporting energy. Three set of nodes 101a are provided at the first location and three set of nodes 101b are provided at the second location. The three set of nodes include branches 901 of the transport channel 107. The branches 902 meeting at a terminal 902. In an embodiment, the terminal 902 receiving concentrated energy from the nodes (source node) through the branches 901. In an embodiment, the terminal 902 transmitting the concentrated energy to another terminal 902. The terminal 902 transmitting the received concentrated energy through the branches for transmitting the energy to the nodes (receiver node).

FIG. 9b illustrating a distribution network of dual node six set apparatus. In an embodiment, transport channels 107 from plurality of terminal 902 meeting at a switch 904. The switch 904 provided for effectively distributing the received concentrated energy to the terminals 902 requiring energy, and the terminals 902 distributing the energy to the nodes 101b.

In an embodiment, the distribution network distributing energy through connections of coupling, splicing, terminals, switching and load balancing between the nodes 101a, 101b.

FIG. 9c illustrating a distribution network of dual node six set and three set booster apparatus. The distribution network including a three set of nodes provides as a booster for increasing collection and concentration of energy.

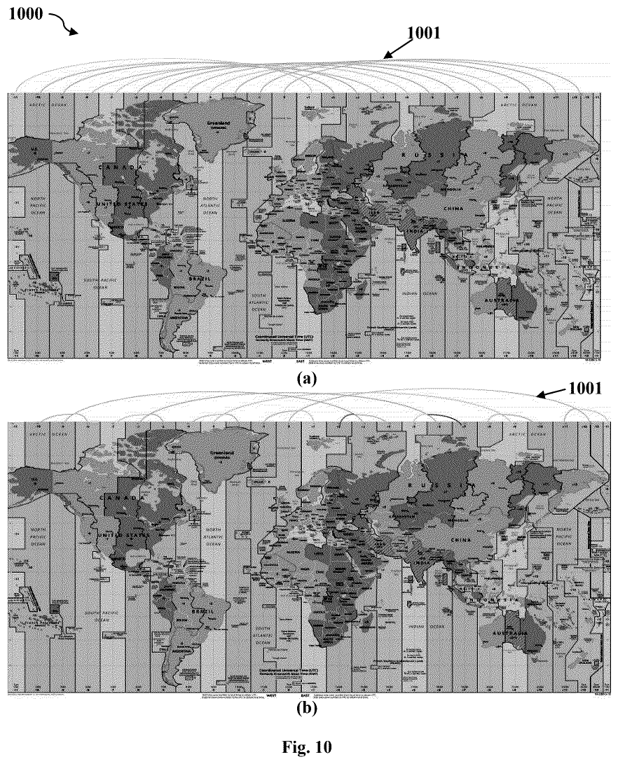

FIG. 10a illustrates a map of the global distribution network linking locations 12 hours apart. Distribution network 1001 links multiple countries in time zone difference of 12 hours for transportation of energy.

FIG. 10b illustrates a map of the global distribution network linking locations 10-14 hours apart. Distribution network 1001 links multiple countries in time zone difference of 10-14 hours for transportation of energy.

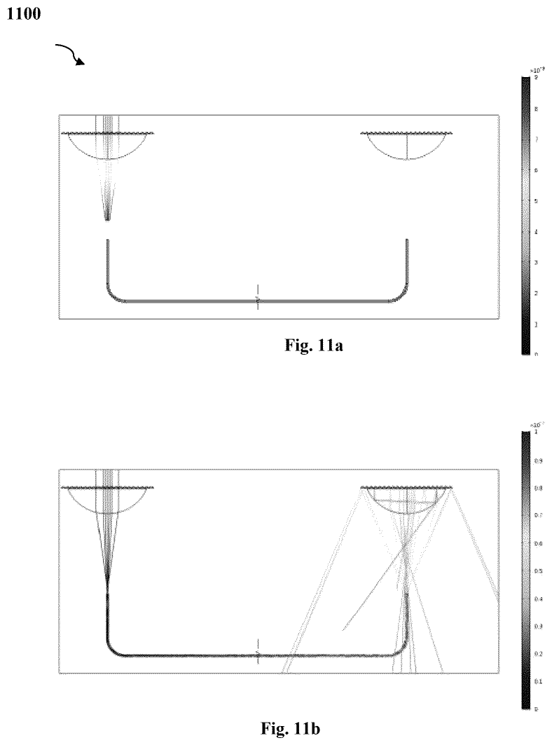

FIGS. 11a and 11b illustrate a 3D ray tracing computational simulation result for the energy in apparatus of FIG. 1a. FIG. 11a illustrates collection of energy by the collector unit, concentration of energy by the concentrator unit and storage of energy in the secondary channel transmitter. FIG. 11b illustrates transmitting energy through the transport channel, release of the energy by the secondary channel receiver, de-concentration of energy through the de-concentrator unit and reflection of energy by the reflector unit.

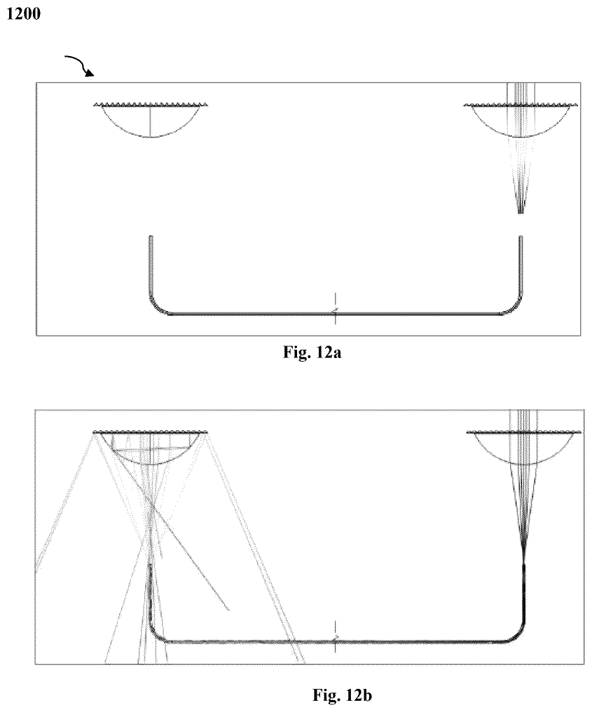

FIGS. 12a and 12b illustrate a 3D ray tracing computational simulation result for the energy in apparatus of FIG. 2a. FIG. 12a illustrates collection of energy by the reflector unit functioning as the collector unit, concentration of energy by the de-concentrator unit functioning as the concentrator unit and storage of energy in the secondary channel receiver functioning as the secondary channel transmitter. FIG. 12b illustrates transmitting energy through the transport channel, release of the energy by the secondary channel transmitter functioning as the secondary channel receiver, de-concentration of energy through the concentrator unit functioning as the de-concentrator unit and reflection of energy by the collector unit functioning as the reflector unit,

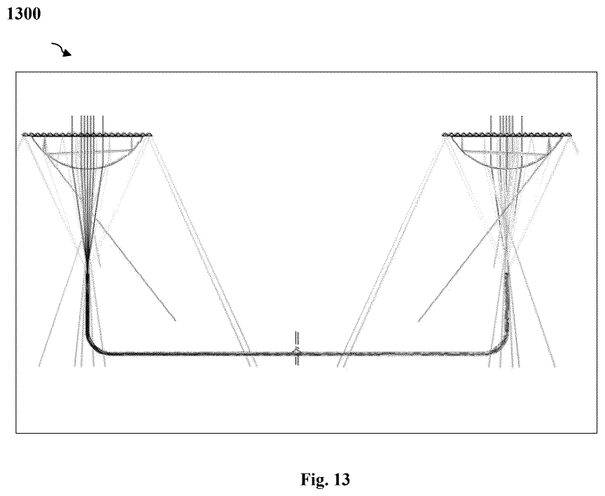

FIG. 13 illustrates a 3D ray tracing computational simulation result for the energy in apparatus of FIG. 3. FIG. 13 illustrates dual way collection, concentration, release and transportation of energy for 24 hours.

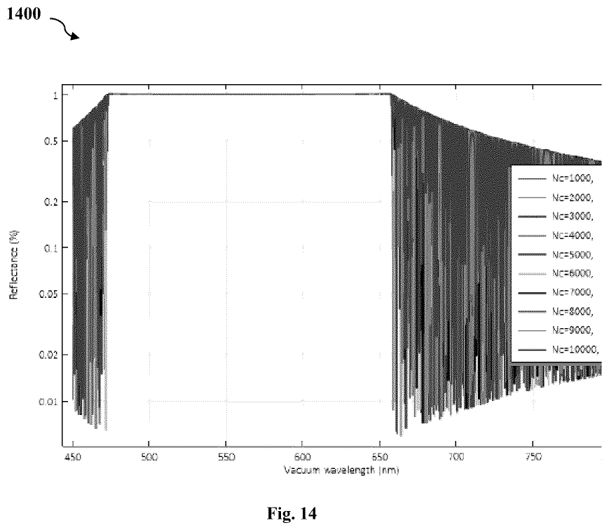

FIG. 14 illustrates a graph of reflectance in % vs vacuum wavelength in nm for solar energy transmission window for air core Brag fibers with multilayer.

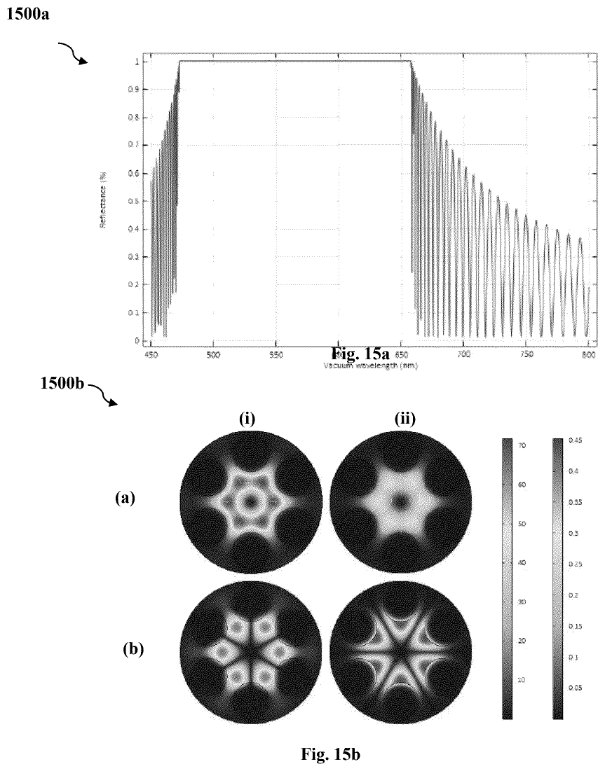

FIG. 15a illustrates a graph of reflectance in % vs vacuum wavelength in nm for solar energy transmission window for Air core Photonic crystal fiber and Meta fiber ballistic transport.

FIG. 15b illustrates computational simulation results for cross-sectional shapes of the transport channel of Air core Photonic crystal fiber and Meta fiber ballistic transport. (i) represents electric field in the transport channel and (ii) represents electric field in the transport channel. (a) represents tangential field and (b) represents longitudinal field. Effective mode index=1.4304.

A main advantage of the present disclosure is that the apparatus and method provides transportation of energy from one location to another location with low loss.

Another advantage of the present disclosure is that the apparatus and method provides collection, storage, transportation and distribution of solar energy between location in different time zones.

Still another advantage of the present disclosure is that the apparatus and method provides a global network of transportation of solar energy from locations in day time zone to locations in night time zone with time zone difference being 3 hours to 18 hours.

Yet another advantage of the present disclosure is that the apparatus and method provides a dual way system of collection, transportation and distribution of energy based on availability of the source of energy.

Still another advantage of the present disclosure is that the apparatus and method provides an economical, cost effective and environmental friendly illumination through direct solar energy.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. An apparatus for collecting, transporting and distributing energy, comprising:
a first node (101a) provided at a first location as a source node for collecting energy emitted from a source;
a second node (101b) provided at a second location as a receiver node for receiving the energy from the source node (101a);
wherein the first node (101a) including:
a collector unit (103) for collecting the energy emitted from the source; and a concentrating unit (104) for concentrating the collected energy;
characterized in that
a secondary channel transmitter (105) for storing and releasing the concentrated energy received from the concentrating unit (104);
a primary channel transmitter (106) connected to the secondary channel transmitter (105) for converging the released concentrated energy; and
a transport channel (107) connected to the first node (101a) and the second node (101b) for transmitting the concentrated energy from the primary channel transmitter (106) to the second node (101b).

2. The apparatus as claimed in claim 1, wherein the second node (101b)
including:
a primary channel receiver (108) for diverging the concentrated energy received from the transport channel (107);
a secondary channel receiver (109) connected to the primary channel receiver (108) for storing and releasing the concentrated energy;
a de-concentrator (110) for scattering the concentrated energy released from the secondary channel receiver (109); and
a reflector (111) reflecting the scattered light for illumination.

3. The apparatus as claimed in claim 1, wherein the second node (101b) functioning as the source node during availability of the source at the second location and the first node (101b) functioning as the receiver node during non-availability of the source at the first location.

4. The apparatus as claimed in claim 3, wherein the second node (101b) including:
a top surface of the reflector unit (111) functioning as the collector unit (103) for collecting the energy;
the de-concentrator unit (110) functioning as the concentrator unit (104) for concentrating the collected energy;
the secondary channel receiver (109) functioning as the secondary channel transmitter (105) for storing and controlling release of the concentrated energy;
the primary channel receiver (108) functioning as the primary channel transmitter (106);
the transport channel (107) transporting the concentrated energy to the first node (101a); and
the first node (101b) including:
the primary channel transmitter (106) functioning as the primary channel receiver (108) for receiving the concentrated energy;
the secondary channel transmitter (105) functioning as the secondary channel receiver (109) for storing and releasing the concentrated energy;
the concentrator unit (104) functioning as the de-concentrator unit (110) for scattering the concentrated energy; and
a bottom surface of the collector unit (103) functioning as the reflector unit (111).

5. The apparatus as claimed in claim 1, wherein the energy is solar energy and the source is the sun.

6. The apparatus as claimed in claim 1, wherein the transport channel (107)
including solid core optical fiber; and
the solid core optical fiber including three layers with three different refractive indices.

7. The apparatus as claimed in claim 1, wherein the transport channel (107)
including air core solar optical fiber; and
the air core solar optical fiber including an air core and an outer portion with graded refractive index.

8. The apparatus as claimed in claim 1, wherein the transport channel including an air core solar brag fiber; and
the air core solar brag fiber including an air core and multi layers of mismatched refractive index.

9. The apparatus as claimed in claim 8, wherein the multi layers of mismatched refractive index one of alternate layer of mismatched refractive index and alternate concentric layer of mismatched refractive index.

10. The apparatus as claimed in claim 1, wherein the transport channel including
an air core photonic crystal fiber; and
the air core photonic crystal fiber including a core with variable refractive index materials.

11. The apparatus as claimed in claim 1, wherein the transport channel (107) including a meta fiber with alternate refractive index material
circumferentially and in inclusions.

12. The apparatus as claimed in claim 1, wherein optical means of the collector unit 103, the reflector unit 111, the concentrator unit 104, the de-concentrator unit 110, the primary channel transmitter 106, the primary channel receiver 108, the secondary channel transmitter 105 and the secondary channel receiver 109 including one or a combination of ray, inference, diffractive, photonic, and meta optical elements.

13. The apparatus as claimed in claim 1, wherein the first location of the first node and the second location of the second node provided at different time zones varying from 3 hours to 18 hours.

14. The apparatus as claimed in claim 1, wherein the distribution of energy around the earth through a distribution network including plurality of nodes (101a) collecting and concentrating energy from the source;
a plurality of branches (901) extending from the nodes (101a) for transmitting the concentrated energy;
a plurality of terminals (902) connected to the branches (901) for receiving the energy from the nodes (101a) and transmitting the concentrated energy;
a switch (904) connected to the terminals (902) for transmitting the concentrated energy to another switch (904) for distribution;
the other switch (904) distributing the energy to plurality of nodes (101b) through the terminals (902) and branches (901) for illumination; and
distributing the energy through connections of coupling, splicing, terminals, switching and load balancing between the nodes (101a, 101b).

15. A method for transporting light, comprising the steps of:
collecting energy from a source by a collector unit provided in a first node;
concentrating the collected energy by a concentrator unit provided in the first node;
storing the collected energy and releasing the stored energy by a secondary channel transmitter provided in the first node;
converging and transmitting the stored energy to a transport channel, by a primary transmitter provided in the first node; and
transporting the energy to a second node, by the transport channel for illumination through reflection.

16. The method as claimed in claim 15, wherein the second node including: receiving and diverging the concentrated energy received from the transport channel (107) by a primary channel receiver (108);
storing and releasing the concentrated energy by a secondary channel receiver (109) connected to the primary channel receiver (108);
scattering the concentrated energy released from the secondary channel receiver (109) by a de-concentrator (110); and
reflecting the scattered light for illumination, by a reflector (111).

17. The method as claimed in claim 15, including distributing the energy around the
earth through a distribution network comprising the steps of:
collecting and concentrating energy from the source, by plurality of nodes (101a);
transmitting the concentrated energy by a plurality of branches (901) extending from the nodes (101a);
receiving and transmitting the concentrated energy by a plurality of terminals (902) connected to the branches (901);
transmitting the concentrated energy to another switch (904) by a switch (904) connected to the terminals (902) for distribution;
distributing the energy by the other switch (904) to plurality of nodes (101b) through the terminals (902) and branches (901) for illumination; and distributing the energy through connections of coupling, splicing, terminals, switching and load balancing between the nodes (101a, 101b).
